(19) United States
(12) Patent Application Publication
(10) Pub. No.: US 2007/0092766 A1
(43) Pub. Date: Apr. 26, 2007

(54) Method and apparatus for desulfurization of fuels

(76) Inventors: Diane M. England, Bloomfield, NY (US); Kaushik Rajashekara, Carmel, IN (US)

Correspondence Address: DELPHI TECHNOLOGIES, INC., M/C 480-410-202, PO BOX 5052, TROY, MI, 48007, US

(21) Appl. No.: 11/256,531

(22) Filed: Oct. 21, 2005

(51) Int. Cl. H01M 8/06; H01M 8/12; H01M 8/04; B01D 11/04

(52) U.S. Cl. 429/19; 429/32; 429/26; 422/255

(57) ABSTRACT

A system for desulfurizing hydrocarbon fuel for a reformer and SOFC stack in an SOFC system. The system comprises a liquid phase desulfurizer for low-temperature desulfurization of an amount of liquid fuel ahead of reformer/stack startup and for continuous removal of large refractory sulfur-containing compounds from low-temperature fuel thereafter during operation of the reformer/stack,and gas phase desulfurizer for continuous high-temperature desulfurization of a stream of vaporized hydrocarbon fuel downstream of the liquid phase desulfurizer. The gas phase desulfurizer may be either upstream or downstream of the reformer.

### TECHNICAL FIELD

The present invention relates to treatment of hydrocarbon fuels; more particularly, to means for removing sulfur from hydrocarbon fuels; and most particularly, to method and apparatus for removing sulfur from hydrocarbon fuels in a small scale continuous process such as is needed for supplying fuel to a fuel cell.

### BACKGROUND OF THE INVENTION

Sulfur is a naturally occurring constituent in petroleum and in most natural gas reserves. When sulfur-containing hydrocarbon fuels are used to power a solid oxide fuel cell (SOFC) stack, sulfur acts as a “poison” to the catalysts in the stack anodes themselves and also in the reformer catalyst used for converting the hydrocarbon fuels into reformate fuel for the fuel cell stack. Such poisoning decreases the activity of catalysts and can decrease the life of metallic parts due to increased corrosion at high temperatures. Therefore, removal of sulfur from hydrocarbon fuels intended for use in SOFCs is imperative to the successful operation of SOFC systems.

Further, the emission of sulfur compounds from the combustion of fuels leads to environmental pollution in the form of acidic oxides of sulfur. Maximum fuel-sulfur content standards in the year 2006 are projected to be as follows:
Gasoline: 30 ppm by weight
Diesel fuel: <15 ppm by weight
JP8 jet fuel: 50 ppm by weight
Natural gas: <10 ppm by weight

In the prior art, several different desulfurization technologies are known, for example, hydrodesulfurization and zinc oxide sorbents. Hydrodesulfurization technologies are currently applicable to large installations such as refineries, and due to their large size and system pressure requirements such technologies are not readily adaptable to mobile, relatively small fuel cell auxiliary power units (APUs) in transportation applications. Chemical scavengers such as zinc oxide are effective for desulfurization in natural gas pipelines, but waste products make them unattractive for mobile systems.

Two promising technologies for fuel desulfurization in small scale, mobile fuel cell applications employ either a) gas phase sorbents based on metal oxides, or b) liquid phase sorbents based on zeolite materials.

Gas phase sorbent technology can work well for a gaseous effluent that does not contain large refractory sulfur-containing organic molecules such as thiophenes, benzothiophenes, and the like. Such molecules tend either to clog gas phase sorbent systems or to slip through the sorbent. Further, such sorbents require elevated temperatures to be effective; thus, at startup of an SOFC system when the sorbents are initially cold there will be no desulfurization and so the system catalysts will be initially poisoned.

Liquid phase sorbents based on zeolite materials can operate over a temperature range from about 0° C. to about 120° C. However, reaction rates for complete desulfurization, down to the levels required for SOFC stacks and reformer catalysts, are unacceptably low; up to six hours may be required.

What is needed is a method and apparatus for continuously desulfurizing hydrocarbon fuel for an SOFC reformer and stack from startup through continuous operation at elevated temperature.

It is a principal object of the present invention to adequately desulfurize fuel being supplied to an SOFC reformer and stack.

### SUMMARY OF THE INVENTION

Briefly described, a system for desulfurizing hydrocarbon fuel for a reformer and an SOFC stack comprises a liquid phase sorbent for low-temperature desulfurization of an amount of liquid fuel ahead of reformer/stack startup and for continuous removal of large refractory sulfur-containing compounds from low-temperature fuel thereafter during operation of the reformer/stack, and a gas phase sorbent for continuous high-temperature desulfurization of a stream of vaporized hydrocarbon fuel downstream of the liquid phase sorbent and ahead of the reformer and the SOFC stack. The liquid and gas phase sorbents cooperating in sequence can reduce the sulfur content in fuel being passed continuously into the reformer to less than about 1.0 ppmv, and in reformate being passed into the stack, to less than 0.1 ppmv.

### BRIEF DESCRIPTION OF THE DRAWINGS

The present invention will now be described, by way of example, with reference to the accompanying drawings, in which:

FIG. 1 is a schematic sequence of operations in a method and apparatus in accordance with the invention;

FIG. 1a is a schematic sequence of operations in an alternate method and apparatus in accordance with the invention;

FIG. 2 is a schematic drawing of an SOFC system equipped for continuous fuel desulfurization in accordance with the invention;

FIG. 3 is a table showing volumes of sorbents arranged in accordance with the invention for continuous reduction of fuel sulfur content from 50 ppm by weight to less than 0.1 ppm by volume for a continuous fuel flow rate of 0.2 g/sec; and

FIG. 4 is a table showing volumes of sorbents arranged in accordance with the invention for continuous reduction of fuel sulfur content from 50 ppm by weight to less than 1.0 ppm by volume.

### DESCRIPTION OF THE PREFERRED EMBODIMENTS

In a fuel desulfurizing process in accordance with the invention, liquid phase desulfurizing of sulfur-containing hydrocarbon fuel is combined with gas phase desulfurizing of partially desulfurized and vaporized fuel to yield a gas phase fuel suitable for reforming and a reformate suitable for use in an SOFC stack.

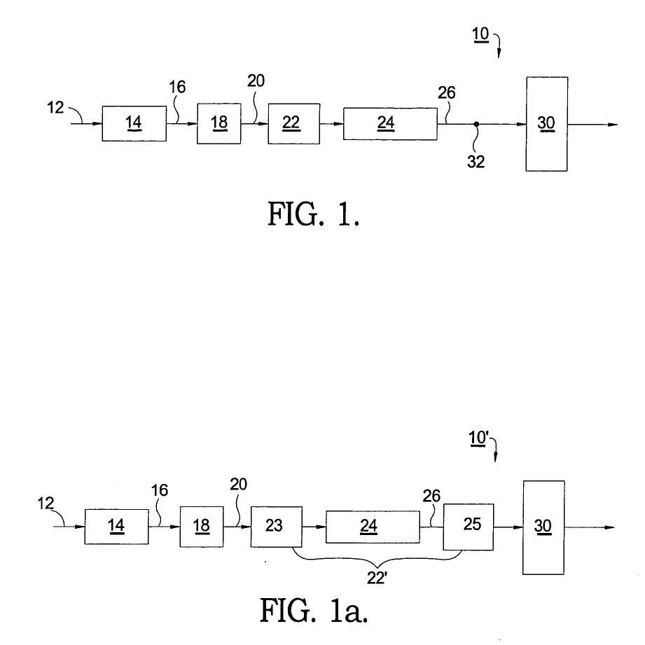

Referring to FIG. 1, in a schematic flow diagram of a desulfurizing system 10 in accordance with the invention, a flow 12 of sulfur-containing hydrocarbon fuel is passed first through a low-temperature, liquid-phase desulfurizer 14, for example, a copper-, silver-, cerium-ion exchanged zeolite sorbent with an alumina guard bed for removing large refractory sulfur-containing compounds in the liquid fuel. Such a zeolite is operative over a temperature range between about 0° C. and about 120° C. Partially desulfurized fuel 16 is then vaporized in a Fuel Delivery Unit (FDU) 18 in the presence of, for example, air and anode tail gas recycle, to form a gaseous fuel 20 which is passed through a gas-phase desulfurizer 22, a hydrocarbon reformer 24 to produce a hydrogen-rich reformate fuel 26, and is then sent to SOFC stack 30. Alternately, gas phase desulfurizer 22 may be coupled to liquid-phase desulfurizer 14 and disposed in series with and down stream of reformer 24 at a point shown as 32 in FIG. 1.

Referring to FIG. 1a, in a preferred embodiment 10′ , liquid-phase desulfurizer 14 may be coupled, in series, with a dual gas-phase desulfurizer 22′ having a coarse sorbent 23 and a polishing sorbent 25. The need for “polishing” sorbent 25 is dependent on the sulfur tolerance of the SOFC anode and the reformer catalyst. The definition of a coarse” sorbent as used herein is a material which can reduce the level of sulfur to approximately 1 to 10 ppmv. A coarse gas phase sorbent can be, for example, a metal oxide such as zinc, copper, or manganese oxides, or a zeolite-like material such as, for example, zinc titanate, or calcium carbonate. The coarse gas-phase sorbent 23 may also be a separation membrane or a liquid material such as a liquid through which gas can be bubbled. A “polishing” sorbent is defined as a material which can reduce the level of sulfur down to sub parts per million levels.

It is known that liquid phase desulfurization alone can provide fuel having extremely low levels of sulfur, on the order of 0.1 ppmw. The majority of the sulfur in the fuel is removed in a relatively short time of approximately 1 to 2 hours, in the temperature range of about −10° C. to about 80° C. Hence, the liquid phase sorbents operate within ambient temperature ranges. Since the liquid phase sorbents remove sulfur from the fuel while the fuel is sitting in the sorbent of liquid-phase desulfurizer 14 at ambient temperature and conditions, the liquid phase sorbent acts as a passive desulfurization system in the sense that no heating or pressurizing of the fuel or sorbent is necessary for desulfurization to occur.

In contrast, gas phase sorbents as used in gas-phaserdesulfurizers 22, 22′, require operation temperatures between about 300° C. and about 850° C., depending on the sorbent material used. By combining liquid phase and gas phase sorbent technologies together, the initial fuel can be desulfurized by the liquid-phase desulfurizer for startup. During operation of the fuel cell, the rate at which the fuel is used by the fuel cell increases such that full desulfurization by the liquid-phase desulfurizer can no longer occur. However, since the gas-phase desulfurizer will have been brought up to operation temperature after the fuel cell is in operation, the sorbents in the gas-phase desulfurizer will clean up what the liquid sorbent cannot. During system cool down, and when the system is at rest, the sorbents of the liquid-phase desulfurizer 14 work to fully desulfurize the fuel to be used for the next startup. Therefore, combining the use of liquid phase and gas phase sorbents result in an optimum continuous desulfurization system.

In a presently preferred sequence of operations, as shown in FIGS. 1 and 1a, when SOFC 30 is not in service, fuel retained in liquid phase desulfurizer 14 continues to desulfurize passively over a period of up to several hours, down to a level at or below 0.1 ppmw. Desulfurizer 14 is provided with a fuel volume such that the SOFC system can be started up and operated on fully desulfurized fuel from desulfurizer 14 for a period of time adequate to warm the sorbent materials in gas-phase sulfurizer 22, 22′ to operating temperature. Then, as less-fully, desulfurized fuel begins passing through liquid phase desulfurizer 14, the gas phase desulfurizer cooperates with the liquid phase desulfurizer to provide low-sulfur fuel at a sulfur content of about 1.0 ppmv continuously to reformer 24 and about 0.1 ppmv to fuel cell stack 30.

As, for example, in the case of requiring uninterrupted operation for 1000 hours without regenerating the sorbents and having a continuous fuel flow rate of 0.2 g/sec wherein the initial sulfur content is 50 ppmw or greater, the liter volumes of sorbents required to provide a continuous sulfur content of less than 0.1 ppmv (as just described) for gasoline, diesel fuel, and jet fuel are shown in FIG. 3. For a gasoline-powered fuel cell, approximately 30 total liters of sorbent is required, the great majority of which is for liquid sorbent 14.

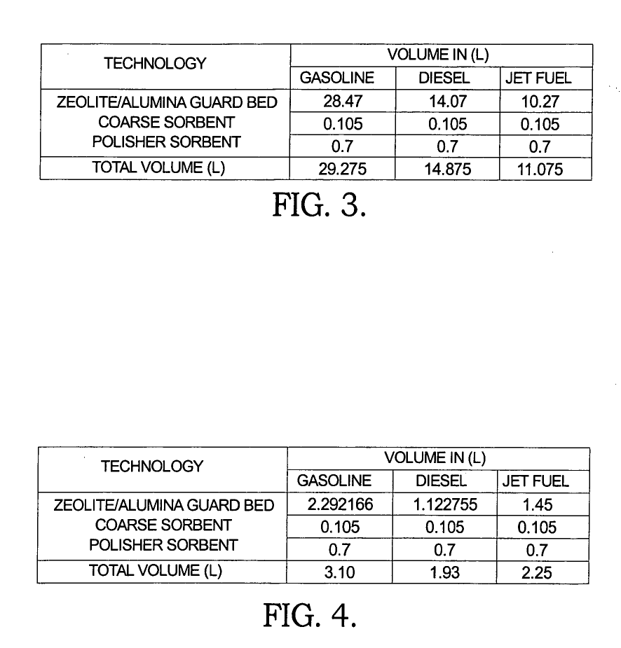

Continuing development of reformer and fuel cell catalysts may result in less sulfur-poisoning sensitivity in future apparatus. Referring to FIG. 4, it is seen that if a future system can tolerate a sulfur level of 1.0 ppmv in the reformer and fuel cell, the volume of a sorbent system is reduced nearly ten-fold to little more than 3 liters. Note that the volumes of the sorbents needed would be much smaller if the regeneration cycle takes place every 10 to 25 hours, instead of every 1000 hours of operation. For example, with a 10 to 25 hour regeneration cycle, the volumes could be reduced by a factor of 10 to 4 times.

In a currently preferred embodiment, liquid phase desulfurizer 14 is a copper-, silver-, cerium-ion exchanged zeolite sorbent with an alumina guard bed. Desulfurizer 14 is sized such that, beginning with fuel at 50 ppmw sulfur content, the output effluent of desulfurizer 14 is about 10 ppmw. Limiting the requirement of desulfurizer 14 to no less than 10 ppmw drastically reduces the volume of sorbent required as compared to prior art single-sorbent embodiments. Because the ion-exchange sorbent removes the large refractory sulfur-containing molecules, the rate and occurrence of plugging of the gas phase sorbents is greatly reduced. The surbent in coarse gas-phase desulfurizer 22 is preferably a packed column or a ceramic or metallic foam filter with the gas phase sorbent, such as zinc, copper, or manganese oxides, or a zeolite-like material such as, for example, zinc titanate, or calcium carbonate, applied to the surface. A polishing gas-phase sorbent desulfurizer 28 preferably includes, for example, a small grained, morphologically altered material such as zinc oxide, copper oxide or manganese oxide, as is known in the prior art.

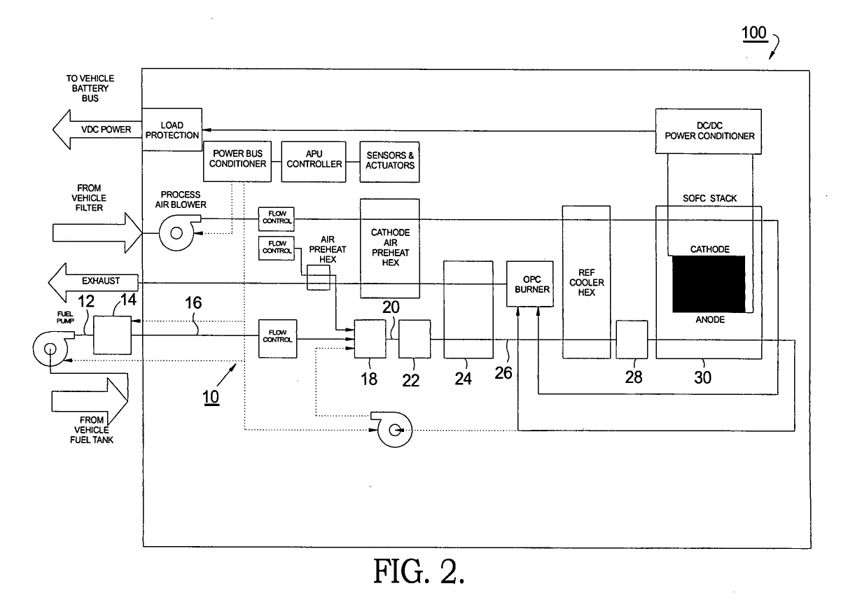

Referring to FIG. 2, an SOFC system 100 is shown, integrating the desulfurizing components 10 shown in FIG. 1.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A desulfurization system for removing sulfur from sulfur-containing hydrocarbon fuel, comprising:
a) a liquid phase desulfurizer for removing a first portion of said sulfur from said hydrocarbon fuel in a liquid state to produce a partially-desulfurized liquid hydrocarbon fuel; and
b) a gas phase desulfurizer following said liquid phase desulfurizer in flow sequence therewith for removing a second portion of said sulfur from said partially-desulfurized hydrocarbon fuel in a gaseous state.

2. A system in accordance with claim 1 further comprising a fuel vaporizer in flow sequence between said liquid phase desulfurizer and said gas phase desulfurizer.

3. A system in accordance with claim 1 wherein said liquid phase desulfurizer includes a zeolite-based sorbent.

4. A system in accordance with claim 3 wherein said liquid phase desulfurizer includes a alumina guard bed.

5. A system in accordance with claim 3 wherein said zeolite-based sorbent material is selected from the group consisting of copper-ion, silver-ion and cerium-ion exchanged zeolite.

6. A system in accordance with claim 1 wherein said gas phase desulfurizer includes a coarse gas phase desulfurizer and a polishing gas phase desulfurizer in flow sequence.

7. A system in accordance with claim 6 wherein said coarse gas phase desulfurizer includes a sorbent material selected from the group consisting of zinc oxide, copper oxide, manganese oxide, zinc titanate and calcium carbonate.

8. A system in accordance with claim 6 wherein said polishing gas phase desulfurizer includes a sorbent material comprised of a morphologically altered oxide.

9. A system in accordance with claim 8 wherein said polishing gas phase desulfurizer includes a sorbent material selected from the group consisting of zinc oxide, copper oxide and manganese oxide.

10. A solid oxide fuel cell system comprising a catalytic hydrocarbon reformer for partially oxidizing hydrocarbon fuel to provide a hydrogen rich reformate and a fuel cell stack for oxidizing said reformate to produce electricity,
wherein said fuel cell system includes a desulfurizer for removing sulfur from sulfur-containing hydrocarbon fuel being supplied to said fuel cell system, and
wherein said desulfurizer includes a liquid phase desulfurizer for removing a first portion of said sulfur from said hydrocarbon fuel in a liquid state to produce a partially-desulfurized hydrocarbon fuel, and a gas phase desulfurizer following said liquid phase desulfurizer in flow sequence therewith for removing a second portion of said sulfur from said partially-desulfurized hydrocarbon fuel in a gaseous state.

11. A system in accordance with claim 10 further comprising a fuel vaporizer in flow sequence between said liquid phase desulfurizer and said gas phase desulfurizer.
